(19) United States
(12) Patent Application Publication
(10) Pub. No.: US 2014/0001767 A1
(43) Pub. Date: Jan. 2, 2014

(54) SANNER CYCLE ENERGY SYSTEM

(71) Applicant: Gunnar Sanner, Stathelle (NO)

(72) Inventor: Gunnar Sanner, Stathelle (NO)

(21) Appl. No.: 13/989,444

(22) PCT Filed: Nov. 25, 2011
(86) PCT No.: PCT/EP11/71041

§ 371 Date: Jul. 18, 2013

(30) Foreign Application Priority Data
Nov. 26, 2010 (NO) 20101664

(51) Int. Cl. H02N 99/00

(52) U.S. Cl. CPC H02N 99/00
USPC 290/1 R

(57) ABSTRACT

The invention concerns an energy system (Sanner cycle), comprising a first energy converting plant located at a first geographical position and a second energy converting plant located at a second geographical position, wherein the first energy converting plant is configured to produce at least one energy carrying compound from at least one energy depleted compound using energy obtained from a non-fossil energy source, wherein the second energy converting plant is configured to produce power, electricity and/or heat by reacting the at least one energy carrying compound such as to form the at least one energy depleted compound, and wherein said energy system further comprises a transporting system configured to transport the at least one energy carrying compound produced in the first energy converting plant to the second energy converting plant and to transport the at least one energy depleted compound produced in the second energy converting plant to the first energy converting plant. The invention is characterized in that the that the energy system forms a closed loop with regard to the energy carrying and energy depleted compounds produced at the first and second energy converting plants, wherein the at least one energy carrying compound produced in the first plant is transported in the closed loop to the second plant as to form a reactant at that plant, and wherein the at least one energy depleted compound produced in the second plant is transported in the closed loop to the first plant as to form a reactant at that plant. Energy conversion plants can also be set up in a network with transportation of energy carrying and energy depleted compounds in-between forming a Sanner cycle network.

### TECHNICAL FIELD

This invention relates to an energy system.

### BACKGROUND OF THE INVENTION

Three megatrends characterize the energy situation of the world. Firstly, the global energy consumption shows a steep growth rate due to development of dense populated areas of the world (Asia, Africa and South-America). Secondly, we are running out of easily available hydrocarbon fuel like oil and gas. Thirdly, accelerated use of fossil fuel is polluting our atmosphere with carbon dioxide (CO₂) possibly causing global warming and increased ecological instability. These megatrends, put together, represent a huge challenge for our civilisation in general. Our policy and decision makers: politicians, scientists and leaders in corporations struggle to find a sustainable way further.

To reduce the amounts of CO₂ released it has been proposed various methods for capturing or recycling CO₂. An example of such a method is separation and final storage of CO₂ below ground. Another example is recycling and reformation of CO₂ into methane (CH₄) as proposed in e.g. WO 2008/054230 and “Advanced materials for global carbon dioxide recycling”, Hashimoto et al., Materials Science and Engineering A304-306 (2001) 88-96.

In the concept proposed by Hashimoto et al. electricity is produced by solar cells in desert areas. At coasts close to the desert, the electricity is used for hydrogen production by seawater electrolysis (water splitting) and the hydrogen produced is used for CH₄ production by reacting hydrogen with CO₂. The CH₄ produced is liquefied and transported by ships to energy consuming, more populated, areas where CH₄ is used as a fuel and allowed to react with air in regular combustion systems. The CO₂ produced in the combustion is separated from other combustion products (mainly water and nitrogen oxides) and recovered, liquefied and transported back to the CH₄ production site at the coast close to the desert. This way CO₂ can be globally recycled. Hashimoto et al. focus mainly on the problems associated with seawater electrolysis and the catalysts for CO₂ conversion and claims that these problems are solved.

Concepts of the Hashimoto-type seem not yet to have been implemented on the large scale they are intended for. A reason for this might be that such large projects are not easy to start. Other reasons may be of technical nature, for instance that the problems related to large-scale seawater electrolysis, CO₂ conversion and/or CO₂ recovering have turned out to be greater than expected.

There is still a need for sustainable large scale energy converting systems that do not release net amounts of CO₂ into the atmosphere.

### SUMMARY OF THE INVENTION

An object of this invention is to provide a sustainable energy system that exhibit an improved possibility of being realized compared to the systems previously presented. This object is achieved by the system defined by the technical features contained in independent claim 1. The dependent claims contain advantageous embodiments, further developments and variants of the invention.

The invention concerns an energy system, comprising a first energy converting plant located at a first geographical position and a second energy converting plant located at a second geographical position, wherein the first energy converting plant is configured to produce at least one energy carrying compound from at least one energy depleted compound using energy obtained from a non-fossil energy source, wherein the second energy converting plant is configured to produce power, electricity and/or heat by reacting the at least one energy carrying compound such as to form the at least one energy depleted compound, and wherein said energy system further comprises a transporting system configured to transport the at least one energy carrying compound produced in the first energy converting plant to the second energy converting plant and to transport the at least one energy depleted compound produced in the second energy converting plant to the first energy converting plant.

The inventive energy system is characterized in that the energy system forms a closed loop with regard to the energy carrying and energy depleted compounds produced at the first and second energy converting plants, wherein the at least one energy carrying compound produced in the first plant is transported in the closed loop to the second plant as to form a reactant at that plant, and wherein the at least one energy depleted compound produced in the second plant is transported in the closed loop to the first plant as to form a reactant at that plant. This is a general embodiment of Sanner cycle energy system. Sanner cycle is a closed loop energy system where energy is loaded up in one energy conversion plant (Energy upload plant) by converting energy depleted compound(s) into energy carrying compounds, the energy carrying compounds are transported to another energy converting plant (Energy offload plant) in another geographical location where the energy is loaded off by converting energy carrying compounds to energy depleted compound(s), the energy depleted compound(s) are transported back to the first energy conversion plant and used for new cycles. Hence, all atoms are cycled around and around, being the building blocks for different molecules during a complete cycle. The energy needed for circulation and transportation in the loop could be extracted utilizing a fraction of the energy carrying compounds, resulting in energy depleted compound(s) that are kept inside the loop. Transport of chemical compounds can be of all types, e.g. ships, pipes and trucks. No chemical compounds are emitted to the environment when a complete Sanner cycle energy system is operated. By setting up effective heat exchangers prior to the energy conversions, energy efficiency is increased. Prior to energy conversion at the conversion plants heat is exchanged from outflowing chemical compounds to inflowing chemical compounds. The building blocks of a Sanner cycle could be noted “Sanner cycle elements”. Sanner cycle elements are characterized by handling of chemical compounds and having no chemical compounds emitted to the outside environment. Energy upload plant, Energy offload plant, transportation elements (e.g no emission pipeline system, no emission ship, no emission truck/car) are examples of such elements.

The terms energy carrying and energy depleted compounds refer to the content of chemical energy of the compounds, i.e. energy is released when one or several energy carrying compounds react and form one or several energy depleted compounds and an input of energy is required to accomplish the reverse reaction. In principle, a certain set of atoms are re-circulated in the inventive system, either in the form of at least one energy carrying compound or in the form of at least one energy depleted compound. At the first plant the compound(s) is/are loaded with chemical energy obtained from the non-fossil energy source and at the second site the loaded chemical energy is taken out as useful energy (e.g. electricity). Since the system is closed there are no environmental pollutions—only primary, non-fossil energy is fed to the system (at the first plant) and only useful output energy is fed out from the system (at the second plant). The chemical products of the first plant form reactants in the second plant and vice versa. By properly positioning the first and second energy converting plants, i.e. by properly selecting the first and second geographical positions, an energy system is provided that makes use of non-fossil or renewable energy that is available at a first deserted location, e.g. by using sun light in a desert or heat from geothermal sources, and that provides useful energy (heat, electricity etc) at a second densely populated location.

The distance between the first and the second geographical positions is typically at least 1000 km but shorter distances are conceivable depending on climate, distribution of population, the magnitude of energy supply and demand, topography between the geographical positions, etc. If the distance is very short it is likely that the non-fossil energy source could be used in a more direct way instead. A minimum distance may be around 100 km.

The term non-fossil energy source refers to a source that does not make use of a fossil fuel, such as coal, petroleum or natural gas. Main non-fossil energy sources are hydroelectric, nuclear, geothermal, solar, tide, wave or wind, or rely on burning of wood or waste. Renewable energy is meant to be energy which comes from natural resources such as sunlight, wind, rain, waves, tides, and geothermal heat, which are renewable (naturally replenished). A non-renewable resource is a natural resource which cannot be produced, grown, generated, or used on a scale which can sustain its consumption rate. These resources often exist in a fixed amount, or are consumed much faster than nature can create them. Fossil fuels (such as coal, petroleum and natural gas) and nuclear power (uranium) are examples. If the primary goal of using the inventive system is to reduce the atmospheric emissions of CO₂ it is possible to use nuclear power as the energy source.

In a first embodiment of the invention the first energy converting plant is configured to produce hydrocarbon (HC) and oxygen (O₂) from carbon dioxide (CO₂) and water (H₂O) using energy obtained from said source, wherein the second energy converting plant is configured to produce power, electricity and/or heat by reacting HC and O₂ such as to form CO₂ and H₂O, wherein the at least one energy carrying compound is the HC and O₂ and wherein the at least one energy depleted compound is the CO₂ and H₂O.

Thus, in this embodiment the system is configured to extract the HC and O₂ produced and transport these energy carrying compounds from the first to the second energy converting plant, as well as to extract the CO₂ and H₂O produced at the second plant and transport these energy depleted compounds from the first to the second energy converting plant.

Besides re-circulation of CO₂ such an energy system enables combustion of the HC in pure O₂ that has been produced in the first plant. Thus, the oxygen that conventionally is considered only as a bi-product of the first plant (or, as in the case of Hashimoto et al., is not paid any attention to at all) is used as a main reactant in the second plant.

Combustion of HC in pure O₂, in contrast to combustion of HC in air that contains only around 20% O₂ and 80% nitrogen gas (N₂), provides for a high efficiency of combustion and no production of nitrogen oxides (NOₓ) compounds. Besides being corrosive, NOₓ-compounds together with non-oxidized nitrogen gas contaminate the CO₂ produced. Thus, combustion of HC in pure oxygen produces relatively pure CO₂ that easily can be recovered and fed/transported back to the first energy converting plant in the closed energy system. This embodiment may be noted Closed Loop Carbon Capture and Recycle (CL CCR). This is a particular embodiment of Sanner cycle energy system.

Besides the elimination of environmental emissions, this embodiment of the invention has the advantage, compared to prior art, that water suitable for HC-production is fed to the geographical location of the first energy plant which makes it possible to avoid the complicated processing of salty seawater and which is necessary if there is no water source at all present at that location.

In a variant of this embodiment the first energy converting plant comprises a first reaction unit configured to split water into hydrogen (H₂) and oxygen (O₂) using energy obtained from said source, and a second reaction unit configured to produce hydrocarbon (HC) and water (H₂O) by reacting carbon dioxide (CO₂) with the H₂ produced in the first reaction unit.

Preferably, the HC is methane, methanol, ethanol, propane, propanol, isopropanol, butane, butanol, pentane, gasoline, bio-gasoline, diesel or bio-diesel.

In a second embodiment of the invention the first energy converting plant comprises a first reaction unit configured to split water into hydrogen (H₂) and oxygen (O₂) using energy obtained from said source, wherein the second energy converting plant is configured to produce power, electricity and/or heat by reacting H₂ and O₂ such as to form water, wherein the at least one energy carrying compound is the H₂ and O₂ and wherein the at least one energy depleted compound is the water.

Thus, in this embodiment the system is configured to extract the H₂ and O₂ produced and transport these energy carrying compounds from the first to the second energy converting plant, as well as to extract the H₂O produced at the second plant and transport this energy depleted compound from the first to the second energy converting plant. This embodiment may be denoted Closed Loop Hydrogen Oxygen Water System (CL HOWS). This is a particular embodiment of Sanner cycle energy system.

At the second plant the H₂ and (pure) O₂ may be allowed to react in e.g. a fuel cell or combustion engine. Using hydrogen instead of HC at the second plant may is, for instance, advantageous when it is suitable to produce electricity directly from fuel cells. Since the oxygen also in this case is pure any problems related to formation of CO and CO₂ in the fuel cells are eliminated.

In a further embodiment of the invention the non-fossil energy source is a renewable energy source, such as solar radiation, wind, wave, flowing water or geothermal heat.

In a further embodiment of the invention the transporting system comprises ships and/or pipelines.

### BRIEF DESCRIPTION OF DRAWINGS

In the description of the invention given below reference is made to the following figure, in which:

FIG. 1 shows, in a schematic view, a first embodiment of the inventive energy system, and

FIG. 2 shows, in a schematic view, a second embodiment of the inventive energy system.

FIG. 3 shows the pressure drop in 1000 km pipeline against pipeline diameter for transport of hydrogen (800 MW heat transport at 10 to 30 bar total pressure.

FIG. 4 shows the pressure drop in 1000 km pipeline against pipeline diameter from transport of oxygen (800 MW heat transport at 10 to 30 bar total pressure.

FIG. 5 shows the principle of the inventive cycle indicating recovery of energy at different temperature levels.

### DESCRIPTION OF EXAMPLE EMBODIMENTS OF THE INVENTION

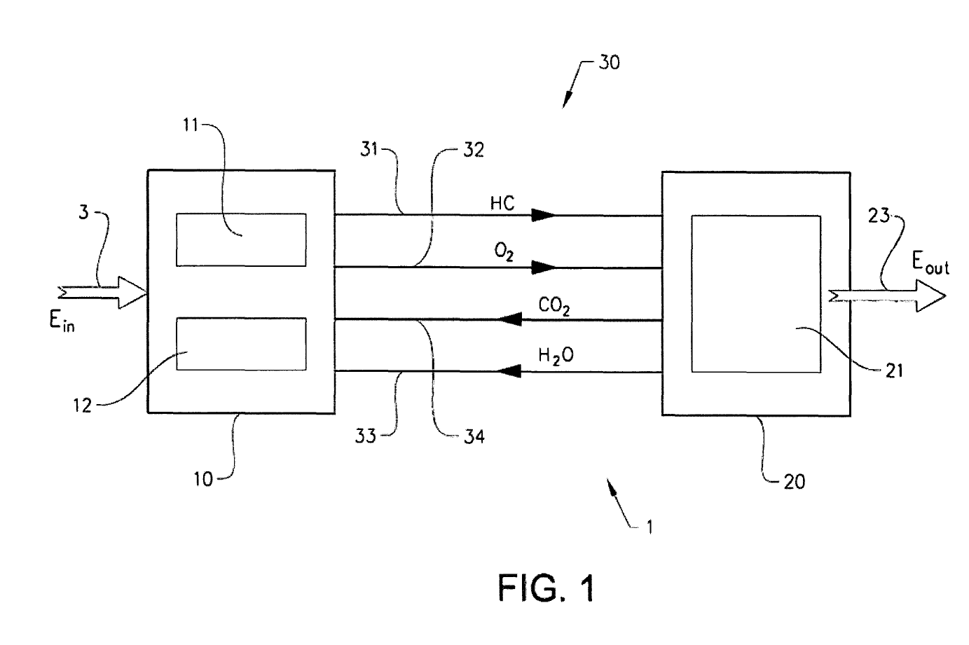

FIG. 1 shows, in a schematic view, an example of a first embodiment of an energy system 1 according to the invention. The system 1 comprises a first energy converting plant 10 located at a first geographical position and a second energy converting plant 20 located at a second geographical position. The first energy converting plant 10 is configured to produce hydrocarbon (HC), in this case methane (CH₄), and oxygen (O₂) from carbon dioxide (CO₂) and water (H₂O) using energy Eᵢₙ (arrow 3) obtained from a non-fossil energy source. For this purpose, the first plant 10 comprises a first reaction unit 11 configured to split water into hydrogen (H₂) and oxygen (O₂) using said energy Eᵢₙ 3. The first plant 10 further comprises a second reaction unit 12 configured to produce HC, in this case methane, and water by reacting CO₂ with the H₂ produced in the first reaction unit 11. The first geographical position is in this example a desert area with a great surplus of energy in the form of heat and light. Thus, the energy source used for obtaining Eᵢₙ is solar radiation.

The chemical reaction in the first reaction unit 11 can be written: Eᵢₙ+4H₂0→4H₂+2O₂, and the chemical reaction in the second reaction unit 12 can be written: CO₂+4H₂→CH₄+2H₂O. Thus, the resulting chemical reaction in the first energy converting plant 10 can be written as: Eᵢₙ+CO₂+2H₂0→CH₄+2O₂.

The first and second reaction units 11, 12 are connected to each other such that hydrogen can be fed from the first unit 11 to the second unit 12 and such that water, and preferably also heat, produced in the second unit 12 can be fed to the first unit 11.

Plants, reaction units, equipment etc. for carrying out the reactions in the first plant 10 are known as such to the person skilled in the art.

The second energy converting plant 20 is configured to produce output energy Eₒᵤₜ (arrow 23) in the form of power, electricity and/or heat by reacting HC and purified O₂, i.e. not air but oxygen substantially free from nitrogen (N₂), such as to form CO₂ and H₂O. For this purpose the second plant 20 comprises a reaction unit in the form of an oxyfuel combustion unit 21. Such a combustion unit is also, as such, known to the person skilled in the art.

The resulting chemical reaction in the second energy converting plant 20 can be written as: CH₄+2O₂→CO₂+2H₂0+Eₒᵤₜ, i.e. in principal the resulting chemical reaction in the first energy converting plant 10 in reverse.

The second geographical position is in this example a densely populated area with a great demand of energy in the form of heat and electricity.

Both plants 11, 12 are configured to extract and separate the resulting chemical compounds produced at each plant.

The energy system 1 further comprises a transporting system 30 configured to transport the methane and oxygen produced in the first energy converting plant 10 to the second energy converting plant and to transport the carbon dioxide and water produced in the second energy converting plant 20 to the first energy converting plant 10. Arrowed lines 31-34 denote transporting means that, for instance, may be pipelines and/or ships. Land vehicles and aircraft are also possible as alternatives or complements.

This means that the chemical products of first plant 10 can be used as reactants at the second plant 20, and vice versa. The energy system 1 thereby forms a completely closed system which may be denoted Closed Loop Carbon Capture and Recycle (CL CCR). This is a particular embodiment of Sanner cycle energy system. Only primary, non-fossil and renewable, energy is fed to the system 1 (at the first plant 10) and only useful output energy is fed out from system (at the second plant 20).

The system can be said to charged at the first plant 10—renewable energy upload (RE Upload)—and to be discharged at the second plant 20.

In this embodiment, methane and oxygen are the energy carrying compounds, whereas carbon dioxide and water are the energy depleted compounds.

It is possible to set up a model for an energy value chain collecting renewable energy from multiple distant sources, convert this to the storable and movable energy carrier, methane (CH₄), transport this to the markets, and deliver the energy to the customers as power and heat. This can be done by using water splitting: 4H₂O+Energy->4H₂+2O₂; and the Sabatier process, an exothermic reaction transforming hydrogen and carbon dioxide to methane and water: CO₂+4H₂->CH₄+2H₂O+Heat. The system 1 has a feedback loop for transporting the discharged energy carriers CO₂ and H₂0 (i.e. the energy depleted compounds), back to the renewable energy area for re-charging. The physical system consists of renewable energy collectors, industrial plants and energy transportation carriers (pipes and ships). These are existing components used today in different industrial context. Put together in a complete system, this represents a Renewable “closed loop” Carbon Capture and Recycling (CCR) value chain, with no chemical emission to the environment (zero CO₂). This is a particular embodiment of Sanner cycle energy system.

By using the nature's carbon cycle as a roadmap, a closed industrial loop for the global energy value chain can be set up, resulting in no atmospheric consequences or imbalances. By converting renewable energy, produced at distant sites, to methane (CH₄)—the main component in natural gas, a flexible proven energy carrier is provided for all types of renewable energy (solar/wind/hydro/wave/geothermal etc.). The return cycle with CO₂ and H₂O is required to get the loop fully closed. Ship transport may be required between nodes in the network, where pipes are not feasible. The ships could then carry the energy depleted components back when picking up new energy loads. Thereby, the return transport do not necessary load heavily to the business case (especially taken into consideration that CO₂-removal might represent an income flow).

By using energy collected with renewable energy collectors, combined with input of H₂O and CO₂, we will have a Power Gas Plant (the first energy converter 10) instead of a Gas Power Plant (such as the second energy converter 20). This represents “The art of running as Gas Power Plant in reverse”, and could be called reversed combustion.

The proven success of wood, coal, oil and gas, as energy providers for the world, is not only about availability, it's also about collectability, movability and storage ability. For instance, there has always been more solar power available in the world than hydrocarbon resources. But, until now there has been technically and economically more feasible to collect energy from the concentrated fossil energy reservoirs, —energy ready to be transported and stored down the value chain. With fast development of technology for e.g. mirror-based solar parks in the desert ( . . . or floating windmill parks, or geothermal parks . . . ) combined with water-splitting and methanization, the Renewable “closed loop” CCR value chain could at a certain point in the future become competitive.

Many different renewable energy sources can be utilized as the energy provider for the water splitting and methanization, such as solar, wind, water, wave, tide, salt energy.

In the system 1 the renewable energy is captured where the natural conditions is optimal. This will be e.g. solar energy in the equator close deserts, wind parks in rough climate, geothermal parks at the hot spots of the earth, or distant hydropower stations far away from cities.

The renewable energy is converted into chemical energy by charging CO₂ to CH₄ by water splitting and methanization. The fuel elements CH₄ and 2O₂ balance the type and number of atoms (and thereby the mass) of the recycling elements CO₂ and 2H₂O. Cooling can be exchanged between input and output component regarding LNG loading operations.

At the consumption site, i.e. at the second plant 20, the methane is combusted with concentrated O₂ (oxyfuel). Heat and electrical energy is produced in the power plants. In this system the power plants will have no emission to the environment; —the resulting CO₂ and water (H₂O) will be kept in the loop and transported back to the “recharging site”.

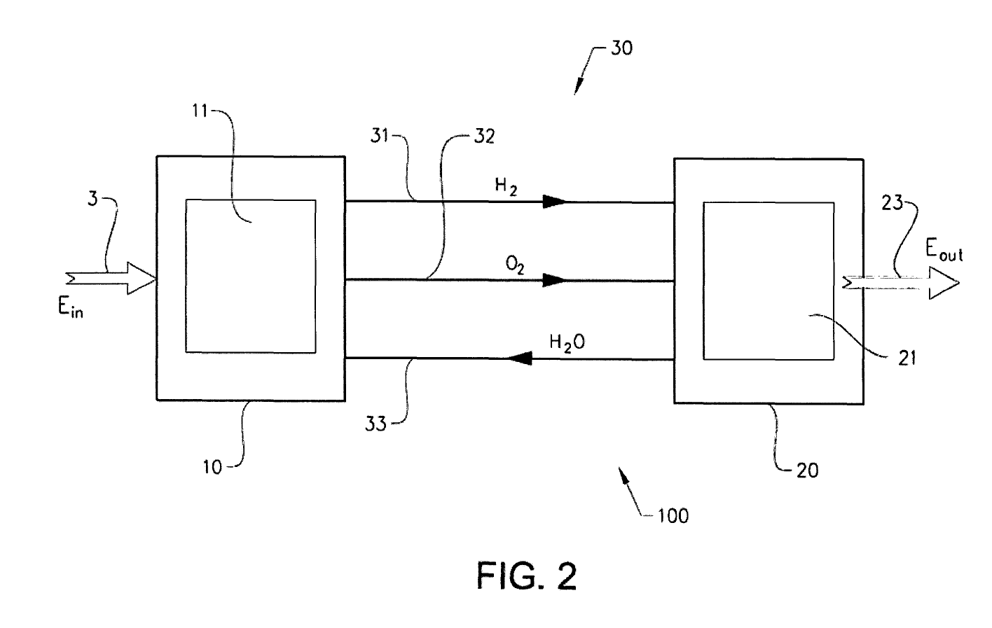

FIG. 2 shows, in a schematic view, an example of a second embodiment of an energy system 100 according to the invention. This embodiment is in many ways similar to the first embodiment described in relation to FIG. 1, and therefore are the same reference numbers used in FIG. 2.

The first energy converting plant 10 comprises also in this second embodiment a first reaction unit 11 configured to split water into hydrogen (H₂) and oxygen (O₂) using energy Eᵢₙ (arrow 3) obtained from a non-fossil energy source. The main difference from the first embodiment is that the second energy converting plant 20 is configured to produce power, electricity and/or heat by reacting H₂ and O₂ such as to form water, and that the transporting system 30 is configured to transport the hydrogen and oxygen produced in the first energy converting plant 10 to the second energy converting plant 20 and to transport (only) the water produced in the second energy converting plant 20 to the first energy converting plant 10. Arrowed lines 31-33 denote the transporting means in this case. The output energy Eₒᵤₜ (arrow 23) is in this case obtained by reacting hydrogen and oxygen in e.g. a fuel cell or combustion engine 21. Other features of the second embodiment are in principal the same as for the first embodiment.

Thus, the at least one energy carrying compound is in this second embodiment the H₂ and O₂ and the at least one energy depleted compound is the water.

As for the first embodiment, the chemical products of the first plant 10 are used as reactants at the second plant 20, and vice versa. The energy system 100 thereby forms a completely closed system which may be denoted Closed Loop Hydrogen Oxygen Water System (CL HOWS). This is a particular embodiment of Sanner cycle energy system.

The inventive energy system 1, 100 is not limited by the embodiments described above but can be modified in various ways within the scope of the claims. For instance, the energy carrying compound may be a single type of compound containing the same atoms as the energy depleted compound(s) and the release of energy at the second plant 20 can be obtained by splitting or re-arranging the energy carrying compound such that the inherent binding energy of the energy depleted compound(s) becomes less than that of the energy carrying compound. At the first plant 10 the energy depleted compound(s) can be combined or re-arranged, using the energy source, as to again form the energy carrying compound.

Moreover, the energy carrying and energy depleted compounds can be other than what is exemplified in the embodiments. For instance, the at least one energy carrying compounds can be the metal and O₂ and the at least one energy depleted compound can be a corresponding metal oxide, or the at least one energy carrying compounds can be carbon and O₂ and the at least one energy depleted compound can be corresponding CO₂.

The energy system can include more than one first energy converting plant, i.e. more than one plant of the charging type, and/or more than one second energy converting plant, i.e. more than one plant of the discharging type. Thus, the transporting system is not limited only to a direct transport between the first and second plants; this transport may be carried out via other first and/or other plants in the system. Similarly, a single plant can include more than one reaction unit working in parallel. Such a energy system could be noted Sanner cycle network. Sanner cycle network is a network of energy conversion plants (nodes) and energy transportation routes (legs) operating according to Sanner cycle principles. Some of the plants (Energy upload plants) load up energy by converting energy depleted compound(s) to energy carrying compounds. Other plants (Energy offload plants), in other geographical areas, load off energy by converting energy carrying compounds to energy depleted compound(s). Between the energy conversion plants there are transportation routes distributing the chemical compounds between the energy conversion plants. Energy carrying compounds are transported from Energy upload plants to Energy offload plants. Energy depleted compound(s) are transported from Energy offload plants to Energy upload plants. Hence, all atoms are kept and transported within the network, being the building blocks for different molecules on their way. No chemical compounds are emitted to the environment when a complete Sanner cycle network is operated.

Further, the carbon dioxide and water produced in the second energy converting plant 20 of the first embodiment do not necessarily have to be separated at the second plant 20 but can be transported before separation.

Moreover, the HC in the first embodiment may be other than CH₄, e.g. methanol (CH₃OH) or ethanol (C₂H₅OH). If so, some of the chemical reactions involved will be slightly different from what is described above. For instance, if the hydrocarbon is methanol the second reaction unit 12 would be a methanolization unit where the main chemical reaction can be written: CO₂+3H₂→CH₃OH+H₂O. The resulting chemical reaction of such a first energy converting plant 10 can be written as: Eᵢₙ+CO₂+2H₂0→CH₃OH+3/2O₂. At the second plant of such a methanol system, the reaction can be written: CH₃OH+3/2O₂→CO₂+2H₂0+Eₒᵤₜ, Thus, the compounds re-circulated between the two plants in an energy system using methanol as HC will be the same as if methane is used. The same holds also for e.g. ethanol.

Further, in the first embodiment it is not necessary to use H₂ to produce HC and oxygen from carbon dioxide and water. This may instead be achieved in a one-step process using heat and/or electricity obtained from the non-fossil source in a more direct way (together with suitable equipment, catalysts etc.). Thus, it is not necessary that the second energy converting plant 10 of the first embodiment comprises any water splitting reaction unit 11.

Heat exchangers may be included in the system to transfer heat between incoming and outgoing flows at either or both plants. This is advantageous both for heating the incoming reactants and for cooling the products that are to be transported to the other plant, possibly in liquid form.

Besides methane, methanol and ethanol, examples of useful hydrocarbons (HC) in the first embodiment are ethane, propane, butane, pentane, gasoline, biogasoline, butanol and diesel.

The first and second plants may operate intermittently and with a varying production rate to account for e.g. variations in the inflow of non-fossil energy at the first plant or variations in the demand for output power at the second plant. To allow for such varying operation the compounds can be accumulated in the transporting system.

The invention shows a surprisingly good potential regarding efficiency as shown in the following modelling example:
The calculations are based on the simplest type of flow: 2H₂O+Energy<=>2H₂+O₂.
Losses in conversion of thermal energy to hydrogen or electric power are not included in the energy upload section.
Ambient temperature: 20° C. (gases and water are cooled to 20° C. during transport)
Heat recovered in streams down to 50° C. (heat content between 20 and 50° C. lost)
Transport distance: 1000 km
Low gas velocity in pipeline: 2-4 m/s
Pressure in UPLOAD unit is higher than the pressure drop in the pipelines as a minimum
Temperature difference in heat exchangers: Minimum 30° C.
No leakage of hydrogen or oxygen during the transport.

The inventive cycle was simulated using Aspen Plus V7.1 process modelling tool.

Sufficient heat and/or electric power (HEAT-POW) are supplied to the UPLOAD unit (assumed to be operated at elevated pressure) to split water molecule into hydrogen and oxygen gases. Warm produced gas (H1-H2 and H1-O2) are used to pre-heat the inlet water stream (WATER) in H1-COLD. It is assumed that the produced gases are cooled to 50° C. upstream the pipelines. Water enter the H1-COLD heat exchanger at 20° C. SEP simulates the separation of hydrogen and oxygen, but this separation process will be part of the UPLOAD unit if use of a water electrolyser unit are assumed. Other options may exist, but this is not part of this evaluation.

Hydrogen and oxygen is transported through 1000 km pipelines. In order to reduce pressure drop to below 5 bar the gas velocity should be around 2 m/s for oxygen and around 3.5 m/s for hydrogen (see below).

Hydrogen is assumed combusted with oxygen in the unit COMB. This may generate a very high temperature (3000-4000° C.) and the reaction chamber must be cooled to a reasonable temperature by an appropriate cooling medium. This cooling medium may be part of a power generating cycle.

In principle a significant amount of the heat (84-85%) that are released can be recovered at a very high temperature (>1000-2000° C.). Since pure hydrogen and oxygen are used in the combustor, heat of condensation of the resulting steam can also be recovered. The heat level depends on the pressure in the condensator, but can typically be recovered between 100 and 200° C. in the COND unit.

The pressure in the cycle is generated by means of a pump. Condensed water is pumped back to the UPLOAD unit through a 1000 km pipeline.

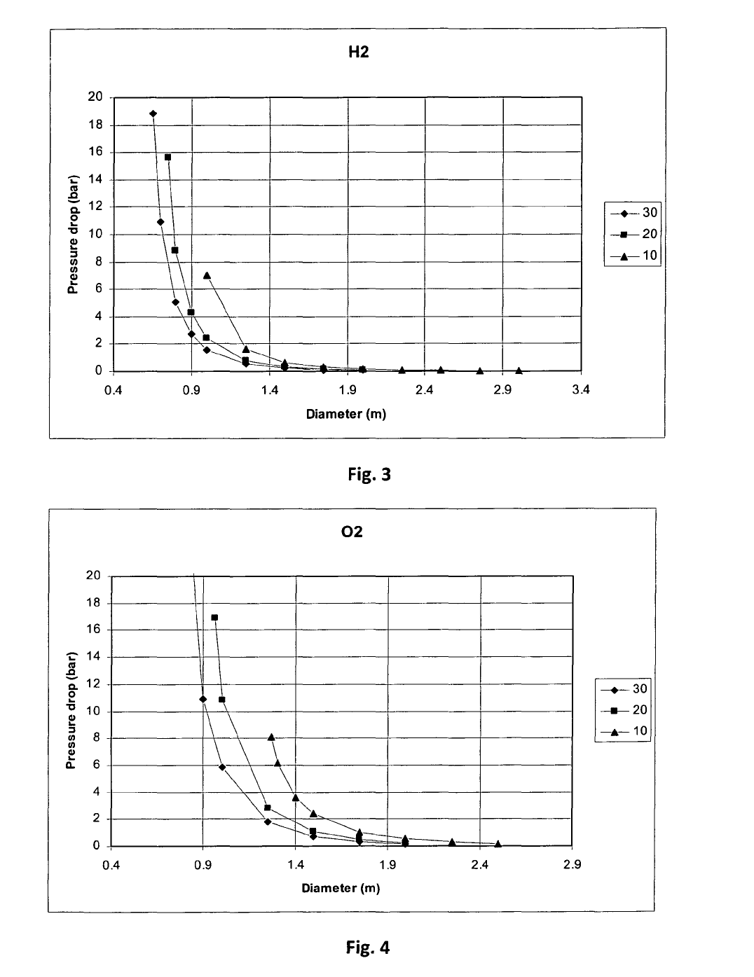

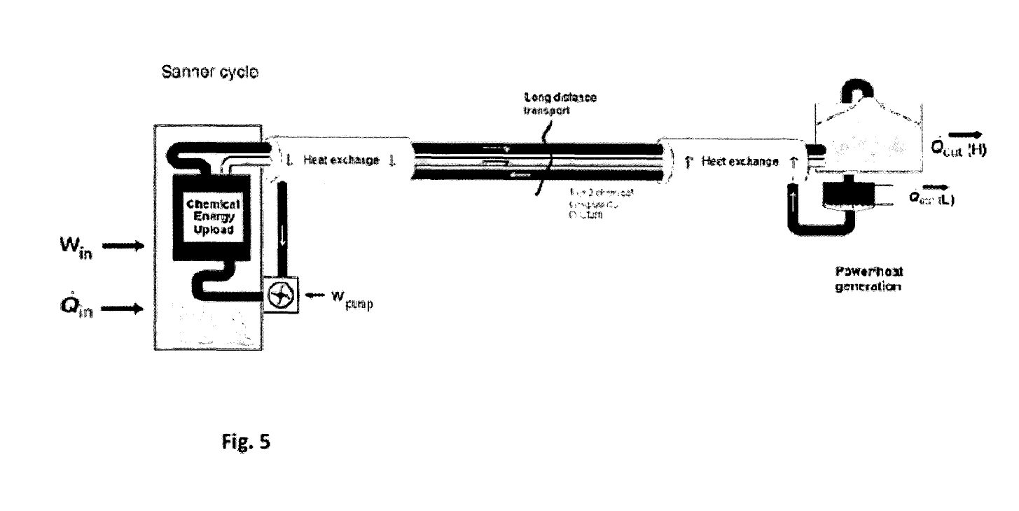

In order to minimise pressure drop in pipelines a rather low gas and water velocity must be used. This of cause may result in rather large pipeline diameters. The model indicates higher pressure drop for transport of oxygen than hydrogen in the proposed cycle indicating that the oxygen pipeline should at least have the same diameter as the hydrogen pipeline (FIGS. 3 and 4). This also indicates that the gas velocity in the oxygen pipeline must be lower than in the hydrogen pipeline to avoid recompression.

FIG. 5 shows the principle of the cycle indicating that heat may be recovered at two different levels; High (H) and low (L). The low level heat can be recovered from condensation of steam and from cooling of condensate from the condensation temperature down to 50° C. The condensation temperature depends on the pressure in the condensator unit.

Simulation runs at different pressures between 20 and 95 bara in the UPLOAD unit gives about the same total efficiency. The only difference is that a higher pressure will allow recovery of the vapour condensation heat at a higher temperature. E.g. with a operating pressure in the UPLOAD unit around 20 bar the pressure in the condensator will be about 13.5 bara resulting in a condensation temperature of about 190° C. At 60 bara the condensation temperature will be about 275° C. There will be a minor amount of heat that can be recovered between the condensation temperature and 50° C. since there is more heat in the water stream than can be used for pre-heating the oxygen and hydrogen feed gases. In a real process flowsheet the GASHEAT unit used will be split in two heat exchangers.

The table below indicates the main efficiency numbers for the proposed cycle. Base case is 100% input as heat and electric power (Wᵢₙ+Qᵢₙ).

TABLE 1
Main efficiency numbers (estimated at 20 bara in UPLOAD unit)

| | |
|---|---|
| Heat & Power input | 100 |
| Qₒᵤₜ (High Temperature)-(1000-2000° C.) | 84.7% |
| Qₒᵤₜ (Low Temperature)- | 12.4% |
| condensation temp. (about 100-275° C.) | |
| Qout (Low Temperature)-Between | 2.0% |
| cond. Temp. and 50° C. | |
| Losses (transport and heat losses) | 0.9% |

Fuel cells may convert hydrogen to electric power with a theoretical efficiency of about 80% if pure oxygen is used as oxidant. The efficiency of a fuel cell (and lifetime) is dependent on the amount of power drawn from it. As a general rule, the more power (current) drawn, the lower the efficiency and operating at maximum 50-60% efficiency is a more likely scenario. Similar to a combustion system using pure oxygen and hydrogen, recovery of most of the heat of condensation will be feasible in a fuel cell system.

In an optimized power cycle around 50-60% of the uploaded heat may be converted to electric power and 49-39% may be used for heating purposes. Modelling of different power generation options will be needed to evaluate this further. However, since oxygen and hydrogen can be transported with only minor losses (1% if no leakage of gases are assumed) this type of energy will be as valuable (and even more) as e.g. natural gas.

Assuming input of 1000 MW (heat and/or electric power) in the UPLOAD unit the following pipeline diameters and velocities will represent a feasible operation (Table 2). Total pressure drop at 20 bara cycle inlet pressure was estimated to 11 bar and assuming 95 bara in the UPLOAD unit will give a total pressure drop of about 35 bara. The pump duty (100-300 kW) is not very significant and some higher pressure drop will be feasible. Especially the water pipeline can be made smaller and several pump station can be included along the line if needed. It is important to avoid gas compression in the system to achieve a very high efficiency, but high pipeline costs may favour some recompression of gases and water even though this will reduce the overall efficiency.

TABLE 2
Pipeline diameter assuming 2 m/s (O₂) and 3.5 m/s (H₂) gas
velocities at different pressure

| | Pressure inlet | | |
|---|---|---|---|
| | gas pipelines, | | |
| | bara | | |
| | 20 | 65 | 95 |
| Hydrogen pipeline diameter, m | 1.3 | 0.75 | 0.63 |
| Oxygen pipeline diameter, m | 1.3 | 0.75 | 0.63 |
| Water pipeline diameter, m | 0.8 | 0.8 | 0.8 |

Assuming the high pressure case (95 bara), scale up to e.g. the capacity of Langeled (31.5 GW) will need 5 hydrogen pipelines each with a diameter of about e.g. 1.6 m or 10 pipelines each with a diameter of about 1.1 m. The same number of pipelines (and dimensions) will be needed for transport of oxygen 1000 km. Reduced distance will increase the capacity in the pipelines.

A long pipeline will have a significant buffer capacity. A 1000 km pipeline with a diameter of 0.63 m will store 311725 m³ gas. If inlet pipeline pressure is 95 bara and exit pressure is 86 bara and production of hydrogen is stopped for 16 hours the pipeline pressure will drop to about 70-73 bara if it is a continuous consumption of hydrogen of about 1 GW. A continuous consumption of 1 GW will in this case need an UPLOAD capacity of 3 GW for 8 hours (e.g. solar based energy upload).

It is demonstrated by modelling that the proposed (H₂O, O₂, H₂) cycle can be operated with a very high efficiency assuming that:
produced oxygen and hydrogen are transported through (separate) pipelines (e.g. 1000 km) without leakage of the gases
transported oxygen (pure) are used in the combustion process instead of air
losses in conversion of thermal energy to hydrogen or electric power are not included (cost of hydrogen production are mainly CAPEX dependent)

Around 84-85% of energy in produced hydrogen (based on High Heating Value) can be recovered at a very high temperature (>1000° C.). Efficient use of this heat is possible (e.g. for generation of electric power). Around 12% of available energy in the transported hydrogen can be recovered at a temperature around 100 to 275° C. (useful for e.g. district heating). This depends on the cycle operating pressure. In addition about 2% of the heat will be available for heating purposes down to about 50° C. indicating a heat transport cycle efficiency of around 99%.

Conversion of thermal energy to either hydrogen or electric power will generate a certain amount of “waste” heat. Some of this heat may be re-used either by heat-exchanging with inlet streams to the process or it can be used for low temperature heating purposes. How much of this energy that will be utilized will always be a question of investment costs verses cost of the energy. In the UPLOAD section of this cycle energy cost is assumed to be close to zero (stranded heat) and investments in capturing and conversion of the heat will be the main cost factor. The efficiency in conversion of heat to hydrogen and oxygen is thus not very important if the investments costs are moderate. Estimation of an efficiency number including losses during hydrogen production is less relevant without including capital costs for this stage.

In the other end of this cycle where hydrogen is burned with oxygen an efficient use of the fuel is very important. Co-transport of oxygen secures a very efficient use of the transported hydrogen fuel, but cost of the oxygen pipeline must be evaluated against the value of heat that can be utilised and potential increased efficiency in conversion of hydrogen to electric power.

The low pipeline velocities will require quite large pipeline diameters that can cause high costs. Leakage of hydrogen during such a long distance may also be a challenge.

The main challenge will be cost efficient conversion of e.g. solar heat to hydrogen and oxygen.

Theoretically the main advantages of this cycle are:
Energy (in form of e.g. hydrogen and oxygen) can be transported with minimal losses in pipelines assuming low gas velocities (2-4 m/s). Total loss of recoverable heat is only 1-3% (depending on ambient temperature and possible use of heat between 50 and 100° C.).
Uploaded heat in form of e.g. hydrogen can be converted to electric power with about the same efficiency as e.g. use of natural gas.
If both oxygen and hydrogen are transported to the energy conversion plant, heat of water condensation (about 15% of available energy content in hydrogen) can be used for heating purposes (100-275° C.). If air are used in the combustion this will be manly lost.
A long pipeline will have a significant buffer capacity. A 1000 km pipeline with a diameter of 0.63 m will store 311725 m³ gas. If production of hydrogen is stopped for 16 hours the pipeline exit pressure will only drop from about 86 to 70-73 bara if it is a continuous consumption of hydrogen of about 1 GW.

1-7. (canceled)

8. Energy system, comprising
a first energy converting plant located at a first geographical position and a second energy converting plant located at a second geographical position,
wherein the first energy converting plant is configured to produce at least one energy carrying compound from at least one energy depleted compound using energy obtained from a non-fossil energy source,
wherein the second energy converting plant is configured to produce power, electricity and/or heat by reacting the at least one energy carrying compound such as to form the at least one energy depleted compound, and
wherein said energy system further comprises
a transporting system configured to transport the at least one energy carrying compound produced in the first energy converting plant to the second energy converting plant and to transport the at least one energy depleted compound produced in the second energy converting plant to the first energy converting plant,
wherein the energy system forms a closed loop with regard to the energy carrying and energy depleted compounds produced at the first and second energy converting plants, wherein the at least one energy carrying compound produced in the first plant is transported in the closed loop to the second plant as to form a reactant at that plant, and wherein the at least one energy depleted compound produced in the second plant is transported in the closed loop to the first plant as to form a reactant at that plant, and
wherein the distance between the first and the second geographical position is at least 100 km.

9. Energy system according to claim 8,
wherein the first energy converting plant is configured to produce hydrocarbon (HC) and oxygen (O₂) from carbon dioxide (CO₂) and water (H₂O) using energy obtained from said source,
wherein the second energy converting plant is configured to produce power, electricity and/or heat by reacting HC and O₂ such as to form CO₂ and H₂O,
wherein the at least one energy carrying compound is the HC and O₂ and wherein the at least one energy depleted compound is the CO₂ and H₂O.

10. Energy system according to claim 9,
wherein the first energy converting plant comprises a first reaction unit configured to split water into hydrogen (H₂) and oxygen (O₂) using energy obtained from said source, and a second reaction unit configured to produce hydrocarbon (HC) and water (H₂O) by reacting carbon dioxide (CO₂) with the H₂ produced in the first reaction unit.

11. Energy system according to claim 10,
wherein the HC is methane, methanol, ethanol, propane, propanol, isopropanol, butane,
butanol, pentane, gasoline, bio-gasoline, diesel or bio-diesel.

12. Energy system according to claim 8,
wherein the first energy converting plant comprises a first reaction unit configured to split water into hydrogen (H₂) and oxygen (O₂) using energy obtained from said source, wherein the second energy converting plant is configured to produce power, electricity and/or heat by reacting H₂ and O₂ such as to form water, wherein the at least one energy carrying compound is the H₂ and O₂ and wherein the at least one energy depleted compound is the water.

13. Energy system according to claim 8,
wherein the non-fossil energy source is a renewable energy source, such as solar radiation, wind, wave, flowing water or geothermal heat.

14. Energy system according to claim 8,
wherein the transporting system comprises ships and/or pipelines.
